(19) United States
(12) Patent Application Publication
(10) Pub. No.: US 2016/0297064 A1
(43) Pub. Date: Oct. 13, 2016

(54) WORKBENCH

(71) Applicant: Bruno MALLINGER, Muenchen (Munich) (DE)

(72) Inventor: Bruno MALLINGER, Muenchen (Munich) (DE)

(21) Appl. No.: 15/036,755

(22) PCT Filed: Nov. 5, 2014
(86) PCT No.: PCT/IB2014/002345

§ 371 Date: May 13, 2016

(30) Foreign Application Priority Data
Nov. 13, 2013 (DE) 10 2013 112 494.1

(51) Int. Cl. B25H 1/12; E06C 1/397; E06C 1/39; B25H 1/04

(52) U.S. Cl. CPC B25H 1/12; B25H 1/04; E06C 1/397; E06C 1/39

(57) ABSTRACT

The invention relates to a workbench (1) with removable toolboxes (2), comprising—a pedestal element (4) with a shelf space (5),—two bar elements (3) that are firmly attached to a bottom (6) of the pedestal element (4).—two swivelling bar elements (7) that are mounted pivotably to the two bar elements (3) or to the pedestal element (4) and that pivot about a rotation axis (8) with respect to the bar elements (3), wherein a rotatable wheel (10) is mounted to the base (9) of each swivelling bar element (7), such that said wheel (10) can be brought into contact with the ground when the workbench (1) is tilted and—at least one tool box (2) with an upwardly opening lid (11) that is mounted between the bar elements (3) and/or the swivelling bar elements (7), wherein the tool box (2) features lateral guiding elements that interact with the corresponding guiding elements of the bar elements and/or of the swivelling bar elements in such a manner that the toolbox (2) is removable from the workbench (1) in an at least partially upward or horizontal direction of motion.

The invention relates to a workbench, in particular for the provision of a storage and work area, and for storing tools. The workbench is particularly suited for use as an elevated standing area.

DE 7010843 describes a three-step ladder with a firmly integrated toolbox. However, the mobility of the ladder is reduced due to the firm integration of the toolbox.

It is thus a task of the invention to specify a workbench that can be used with greater mobility compared to the workbenches known to date.

To solve the above problem, we suggest a workbench with a removable toolbox comprising:
a pedestal element with a shelf space,
two bar elements that are firmly attached to the bottom of the pedestal element,
two swivelling bar elements that are mounted pivotably to the two bar elements or to the pedestal element and that pivot about a rotation axis to the bar elements, wherein a rotatable wheel is mounted to the base of each swivelling bar element such that the wheel makes contact with the ground when the workbench is tilted and
   at least one toolbox with an upwardly opening lid, said toolbox being mounted between the bar elements and/or the swivelling bar elements, wherein the tool box comprises lateral guiding elements that interact with the corresponding guiding elements of the bar elements and/or of the swivelling bar elements in such a manner that the tool box is removable from the workbench in an at least partially upward or horizontal direction.

Removal of at least one toolbox can preferably be effected without the use of tools in just one action. ABS plastic, i.e. acrylonitrile butadiene styrene, a particularly impact resistant and light material is suitable for both the toolboxes and for the structural elements of the workbench.

In a preferred embodiment, the guiding elements of the tool box and/or the bar elements and/or the swivelling bar elements are designed as guide slots or grooves and the guiding elements of the bar elements and/or swivelling bar elements and/or the tool box as engagement elements, in particular as guide pins.

In a further embodiment, at least two toolboxes are arranged between the bar elements allowing storage of additional tools. It should be understood that a larger number of toolboxes results in a better organisation of tools. It is thus an option to only store tools and accessories for electrical installation in one toolbox and tools, for say tiling, in another toolbox.

In a further embodiment, at least two toolboxes are arranged between the swivelling bar elements. On the one hand, this generates additional room to store further tools. On the other hand, it increases the stability of the workbench since the weight of the toolboxes is evenly distributed. In addition, the available area to access the tools in the toolboxes can be doubled if the toolboxes are attached to the workbench and open upwards.

In a further embodiment, the utility of the workbench is increased by the fact that at least one bar element and/or pedestal element features a mount for the attachment of a tool, in particular, of a clamping device. In this case the, pedestal element in particular not only serves as a surface for depositing items, that is a shelf space, but also as a work surface for working on an item mounted in a clamping device, for instance a one-handed clamping device.

In a further embodiment, the mount for the attachment of a tool is an opening into which a body of the tool can be inserted and fixed by means of an interlocking fit or a force fit.

In a further embodiment, the pedestal element and/or the toolboxes comprise handle elements, in particular in the form of recesses, which simplify the handling accordingly, i.e. in particular when transporting the workbench and/or removing from and/or inserting tools into the toolboxes of the workbench.

In a particularly preferred embodiment, the shelf space of the pedestal element is designed as a stepping surface for a person. The workbench's utility is thus increased since the work area, for example when installing lights, can be extended all the way to the ceiling level.

In a further embodiment, at least one rung is still available between the bar elements and/or the swivelling bar elements in order to facilitate stepping onto the pedestal element and/or to vary the height at which one works.

In a further aspect, the workbench may comprise at least two rungs arranged between the swivelling bar elements and the bar elements respectively. In particular, rungs can also be arranged between two toolboxes and/or over or under a toolbox in such a manner that it is possible to step on the rung even with the toolboxes mounted on the workbench.

A preferred workbench comprises a work height of the shelf space between 80 cm and 100 cm, preferably 90 cm. In this manner, the handling area, i.e. the area that a person can access with their hands without moving their location, is taken into account with the dimensions of the workbench. The internal handling area, that is the area that can be reached with both hands, then includes the shelf space. The external handling area, that is the area that can be reached with just one hand, preferably encompasses the toolbox at least partly, i.e. when bending down slightly. The toolbox's hinges are preferably mounted at a height of between 50 and 60 cm, more preferably at 55 cm. When opened, the lid of each toolbox is preferably tilted outwards at an angle of approximately 10 degrees in relation to the horizontal plane.

The insides of the toolboxes open downwards together with the extended bars in relation to the vertical plane at an angle of preferably about 20 degrees. The width of the shelf space is preferably between 30 cm and 70 cm, and more preferably between 35 cm and 50 cm.

Embodiments of the invention are explained below with reference to schematic figures. The figures show:

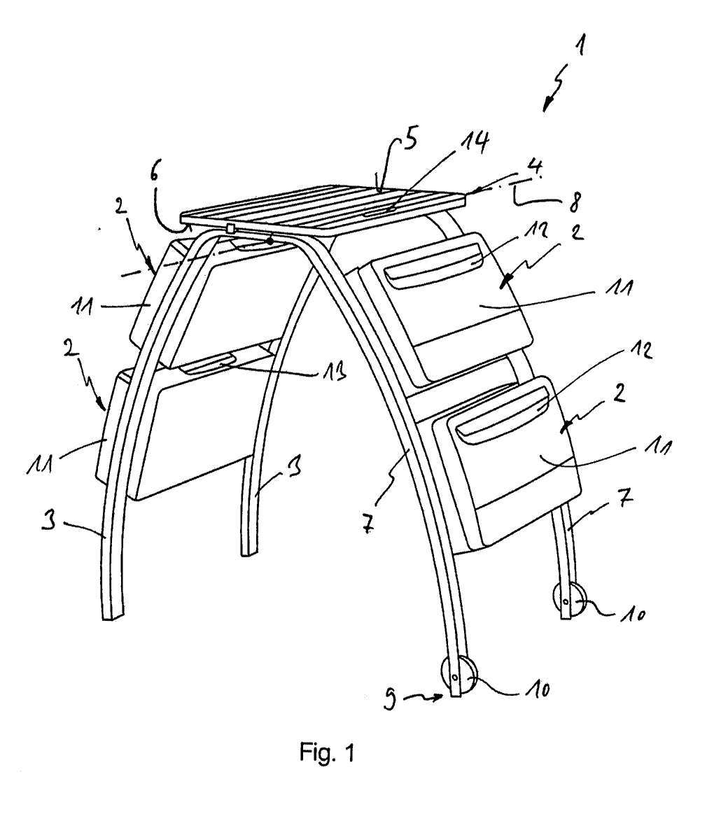

FIG. 1 a workbench in perspective view,

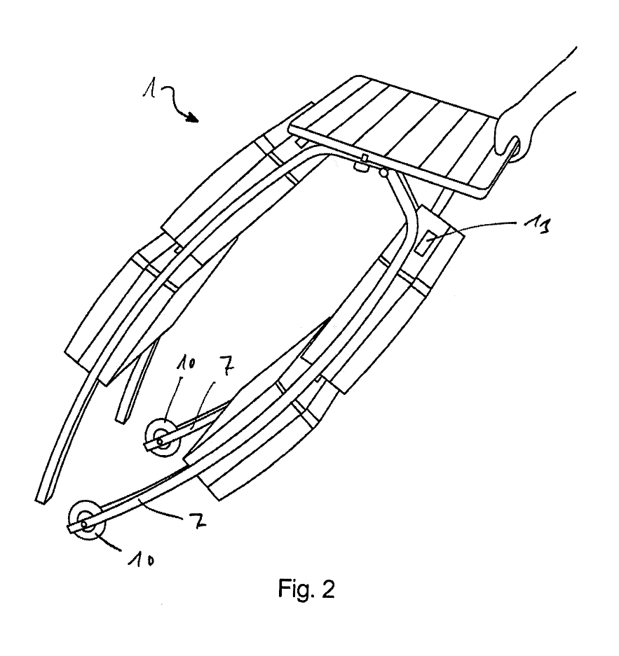

FIG. 2 the workbench of FIG. 1 in transport mode and

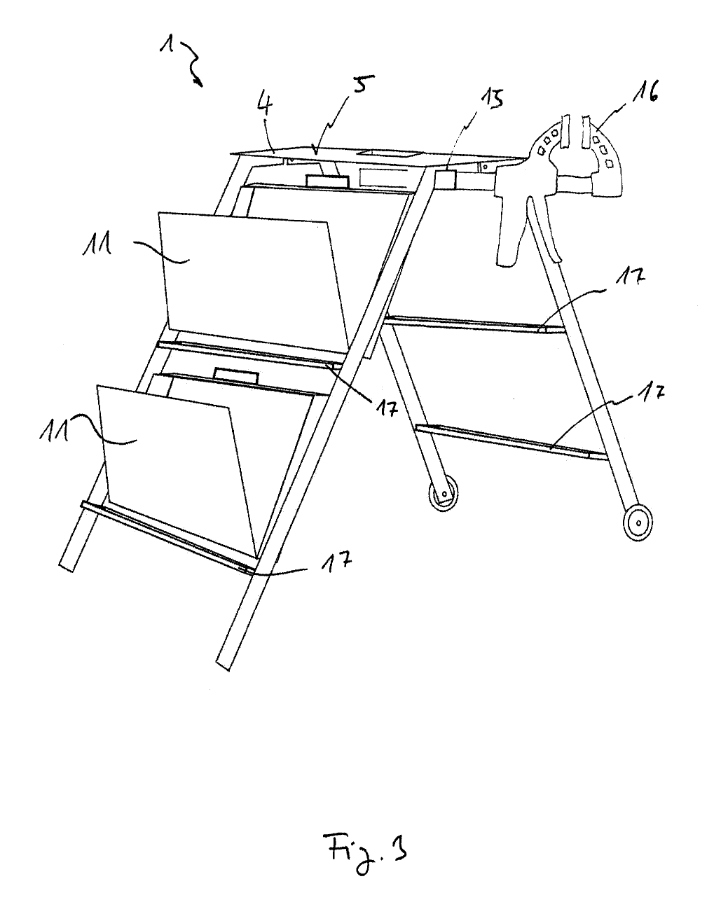

FIG. 3 another workbench embodiment in perspective view.

FIG. 1 shows a workbench 1 with four removable toolboxes 2. A pedestal element 4 with a shelf space 5 at a height of 90 cm is connected 6 to two bar elements 3 at its bottom by means of screws (not shown here). In addition two swivelling bar elements 7 are shown that are mounted pivotably to the two bar elements 3 such that said two swivelling bar elements 7 may pivot about rotation axis 8 to the bar elements. At the base 9 of each swivelling bar element a rotatable wheel 10 is mounted that comes into contact with the ground when the workbench 1 is tilted.

The toolboxes 2 each come with a lid 11 that opens upwards (FIG. 3 illustrates the direction in which it opens) between the bar elements 3 and/or the swivelling bar elements 7. Each toolbox 2 has a lateral guiding element (not shown here) that interacts with the corresponding guiding elements of the bar elements 3 and/or of the swivelling bar elements 7 in such a manner that the toolbox 2 can be detached from the workbench in a horizontal direction of motion without the use of a tool. In FIG. 1 the guiding elements of the toolbox 2 are shown as grooves and the guiding elements of the bar elements 3 and of the swivelling bar elements 7 as guide pins.

Furthermore, handle elements 12 are integrated into the lids 11 and handle elements 13 into the toolboxes 2. Another handle element 14 is shown at the pedestal element which facilitates the handling of the workbench, in particular easy tilting of the workbench 1, as depicted in FIG. 2.

FIG. 2 illustrates the simple transport of the workbench. The swivelling bars 7 are no longer in contact with the ground in this position even though they extend beyond the wheels 10. In FIG. 1, however, the wheels 10 are no longer in contact with the ground, in order to ensure safe positioning of the workbench. 5. Workbench according to any one of the above claims, whereby at least one bar element and/or pedestal element features a mounting element for the attachment of a tool, in particular of a clamping device.

FIG. 3 illustrates in a simplified diagram another workbench with a mounting element 15 for the attachment of a tool 16 here a one-hand clamping device with an opening into which the body of a tool can be inserted and fixed by means of an interlocking fit or a force fit. The shelf space 5 of the pedestal element 4 is designed as a stepping surface for a person. The workbench furthermore comprises four rungs 17 that are arranged between the bar elements and/or the swivelling bar elements. In contrast to the workbench depicted in FIGS. 1 and 2, where the bars are curved inwards, the bars of the workbench in accordance with FIG. 3 are arranged in a straight line.

1. Workbench (1) with removable toolboxes (2), comprising
a pedestal element (4) with a shelf space (5),
two bar elements (3) that are firmly attached to a bottom (6) of the pedestal element (4).
two swivelling bar elements (7) that are mounted pivotably to the two bar elements (3) or to the pedestal element (4) and which pivot about a rotation axis (8) to the bar elements (3), wherein a rotatable wheel (10) is mounted at the base (9) of each swivelling bar element (7) such that said wheel may be brought into contact with the ground when the workbench (1) is tilted and
at least one tool box (2) with an upwardly opening lid (11), said toolbox being mounted between the bar elements (3) and/or the swivelling bar elements (7), wherein the toolbox (2) comprises lateral guiding elements that interact with the corresponding guiding elements of the bar elements and/or of the swivelling bar elements in such a manner that the toolbox (2) is removable from the workbench (1) in an at least partially upward or horizontal direction of motion.

2. Workbench (1) according to claim 1, wherein the guiding elements of the toolbox and/or of the bar elements and/or swivelling bar elements are designed as guide slots or grooves and the guiding elements of the bar elements and/or of the swivelling bar elements and/or the toolbox as engagement elements, in particular as guide pins.

3. Workbench (1) according to claim 1, wherein at least two toolboxes (2) are arranged between the bar elements (3).

4. Workbench (1) according to claim 1, wherein at least two toolboxes (2) are arranged between the swivelling bar elements (7).

5. Workbench (1) according to claim 1, wherein a mounting element (15) for the attachment of a tool (16), in particular of a clamping device, is available at least at one bar element (3) and/or at the pedestal element (4).

6. Workbench (1) according to claim 5, wherein the mounting element (15) for the attachment of the tool is an opening into which the body of a tool can be inserted and fixed by means of an interlocking fit or a force fit.

7. Workbench (1) according to claim 1, wherein handle elements are integrated in the pedestal element and/or the toolboxes (12, 13, 14), in particular in the form of recesses.

8. Workbench (1) according to claim 1, wherein the shelf space of the pedestal element (4) is designed as a stepping surface for a person.

9. Workbench (1) according to claim 1, further comprising rung (17) arranged between the bar elements (3) and/or the swivelling bar elements (7).

10. Workbench (1) according to claim 1, wherein at least two rungs (17) are arranged between the swivelling bar elements (7) and the bar elements (3) respectively.

11. Workbench (1) according to claim 1, wherein the work height of the storage area (5) lies within a range between 80 cm and 100 cm.
